(19) United States
(12) Patent Application Publication
(10) Pub. No.: US 2008/0197554 A1
(43) Pub. Date: Aug. 21, 2008

(54) Flexible Clamping Jaw for a Vise

(75) Inventor: Jasko Sabanac, Stockholm (SE)

Correspondence Address: BACHMAN & LAPOINTE, P.C., 900 CHAPEL STREET, SUITE 1201, NEW HAVEN, CT, 06510, US

(73) Assignee: SYSTEM 3R INTERNATIONAL AB, Stockholm (SE)

(21) Appl. No.: 12/065,329

(22) PCT Filed: Jun. 10, 2006
(86) PCT No.: PCT/EP2006/005585

§ 371 Date: Feb. 29, 2008

(30) Foreign Application Priority Data
Sep. 7, 2005 (EP) 05019409.1

(51) Int. Cl. B25B 1/24

(52) U.S. Cl. 269/138; 269/257

(57) ABSTRACT

A clamping jaw for a vise, comprising a clamping plate and at least two bridges. The clamping power K applied to the clamped workpiece by the clamping plate can be varied along the surface facing the workpiece.

### BACKGROUND OF THE INVENTION

The invention relates to a clamping jaw for a vise, comprising a clamping plate and at least two bridges.

For the accurate machining of a workpiece, for example in an electrical discharge machine, machine tool, etc., it is necessary for the workpiece which is to be machined to be firmly clamped against the vise bed. However, it is possible for the workpiece to move slightly away from the vise bed during the clamping. This uncertainty may lead to inaccuracies.

EP 0 196 544 A1 discloses a vise having a bed, rising above which is a first fixed clamping jaw which has a first clamping plate, and having a second clamping jaw which is movably guided on the bed, has a second clamping plate and is rotatably connected to a spindle rotatably fastened to the bed, the spindle extending in a longitudinal passage formed in the bed and being enclosed in the longitudinal passage by the root of the second clamping jaw, which is connected to the second clamping plate via a neck captively retained in a longitudinal slot of the bed. For the exact positioning of a workpiece clamped between the clamping jaws, provision is made for the bed to have a flat reference surface extending transversely to the clamping plates and between the latter, for at least two adjacent clamping surfaces extending in the direction of the reference surface to be formed on the bed, of which a first clamping surface is inclined relative to the reference surface and the second clamping surface is inclined relative to the reference surface in the opposite direction, and for at least two gripping surfaces adjacent to the clamping surfaces to be formed on the second clamping jaw, of which the first gripping surface extends parallel to the first clamping surface and the second gripping surface extends parallel to the second clamping surface. As a result, a very narrow configuration of the vise is made possible, and this configuration makes said vise especially suitable for use on a wire-cutting electrical discharge machine.

A further clamping device is disclosed in EP 0 362 753. It serves to hold workpieces and to this end has clamping jaws which are adjustable relative to one another at a distance apart and have clamping surfaces pointing toward one another. A work rest is also present. A draw-down device which can be adjusted by the workpiece to be clamped and can be acted upon in the clamping direction is provided at the clamping surface or clamping surfaces of the clamping jaws. Said draw-down device has a draw-down element which projects beyond the clamping surface and points obliquely toward the work rest. During the clamping operation, this draw-down element is acted upon and pivots downward at an angle in the direction of the work rest in the process, the workpiece either being carried along or else being acted upon by force in this direction, such that reliable bearing on the work rest is effected.

German Laid-Open Specification DE 43 41 744 A1 shows a pull-down clamping system for clamping devices on machines for processing workpieces, consisting of two opposite parts—a stop pull-down clamp having fixed clamping jaws and a pull-down clamp having movable clamping jaws, between which the workpiece to be machined is clamped, a stop pull-down clamp being present as a fixed stop part which consists of a jaw body which is arranged on a retaining plate, the jaw body being equipped with protective jaws for clamping a workpiece, said protective jaws having a vertical clamping surface relative to the retaining plate, the jaw body bearing against a rest and having an elastically bendable part relative to the retaining plate and a form design, as a result of which, when a thrust force acting parallel to the retaining plate is effective via the protective jaws, a force which is directed toward the retaining plate and is greater than the lifting force is transmitted to the workpiece.

A main requirement for an optimal clamping system is clamping of a workpiece which must not move away from the vise bed during the clamping and in the clamped state. For example, in wire-cutting electrical discharge machines, the workpiece is acted upon by flowing water up to pressures of 100 bar during the machining in order to flush away chips or waste material. This may lead to vibrations of the clamped workpiece, and these vibrations may have an adverse effect on the accurate clamping of the workpiece. The problem in the prior art is that the required strength during the clamping of a tool is not achieved on account of more exacting application requirements. For example, workpieces are becoming larger, and therefore a clamping device of the present type must also be capable of optimally clamping workpieces which are relatively large compared with the size of the clamping tool. For example, wire-cutting electrical discharge machines have higher working speeds. This requires higher water pressures for removing the accumulating chips, which in turn results in greater loading of the workpiece.

A further disadvantage is the use of protruding workpieces on account of a loading capacity that is too low. A projecting workpiece produces a certain bending moment which can adversely affect the clamping force.

It may be physically disadvantageous for an operator (stressing of the joints and muscles) if, for example, the vise has to be operated manually many times in succession by means of a wrench.

It is therefore the object of the invention to avoid all these disadvantages, namely to increase the clamping force at the same operating force in the direction of the vise bed and to increase the clamping strength.

According to the invention, the object is achieved in that the clamping force of the clamping plate on the clamped workpiece is variable along the surface directed toward the workpiece.

Due to the variable clamping force of the clamping jaws, an increase in the torque is achieved by the resultant clamping force preferably lying above the center of the surface of the clamping plate.

According to a further configuration of the invention, the clamping plate has an outer bridge and an inner bridge.

Furthermore, the outer bridge and the inner bridge may be elastically flexible in the clamping direction, the spring constant of the inner bridge being less than the spring constant of the outer bridge.

According to the subclaims, the bridges are curved, in which case the bridges may be curved differently.

For example, the inner bridge has a greater curvature than the outer bridge.

By one or more of these measures, a displacement of the application point of the clamping force parallel to the vise bed is achieved, resulting in an increase in the torque which acts on the workpiece. Consequently, the strength of the clamping in the direction perpendicularly to the vise bed is increased. The essential feature is the achievement of a maximum loading capacity. The loading capacity is provided for by the maximum bending moment, which is a function of the resultant forces on the workpiece. The loading capacity is substantially increased with this invention.

Furthermore, the requisite torque which the operator has to apply is reduced in order to achieve the same loading as in the prior art. This is beneficial to the health of the operator.

According to a preferred embodiment, the inner bridge is of S-shaped configuration. The invention is not restricted to the S-shaped configuration of the bridge. All shapes which lead to the aim of increasing the clamping force and loading capacity are conceivable.

### SUMMARY OF THE INVENTION

According to the invention, the clamping jaw may have a cavity between the bridges, the curvatures of the cavity being appropriately designed for avoiding overloading.

### BRIEF DESCRIPTION OF THE DRAWINGS

Furthermore, the clamping jaw may have a curved slot below the inner bridge for avoiding overloading.

The slot serves as a safety feature to prevent overloading of the clamping tool. The slot width is a geometrical measure of the maximum permitted loading.

The invention is described below with reference to an exemplary embodiment. In the drawing:

FIG. 1 shows a vise according to the prior art,

FIG. 2 shows a side view of a vise,

FIG. 3 shows a three-dimensional view of a clamping jaw,

FIG. 4 shows a side view of a clamping jaw,

FIG. 5a shows the force relationships in the prior art,

FIG. 5b shows the force relationships according to the invention.

### DETAILED DESCRIPTION

A vise 2 having clamping jaws 11 and 12 known according to the prior art is shown in a three-dimensional illustration in FIG. 1. The clamping jaw 11 is firmly connected in one piece to the vise body 13. Holes 14 for fastening to a work table in a manner known per se are provided in the vise body 13. Arranged on the side of the fixed clamping jaw 11 is the vise bed 15, on which the workpiece 6 shown in FIG. 2 is clamped in place. Below the vise bed 15, a spindle arrangement 16 is installed in the interior of the vise body 13. The spindle arrangement 16 consists in a conventional manner of a spindle 22 which is secured on the one side of the vise body 13 by means of a nut 17 and is closed off on the other side by a rotatable handle 18 for actuating the spindle 22. A clamping jaw 12 guided in the vise body 13 is moved by means of the spindle 22 for clamping a workpiece 6 between the clamping jaws 11 and 12. According to the prior art, the clamping jaws 11 and 12 have two bridges 19 and 20. A parallelogram-shaped cavity 21 is shown between the bridges 19 and 20.

FIG. 2 shows a side view of a vise with an exemplary embodiment of the clamping jaws 1. A workpiece 6 is clamped in position in the clamping jaws 1. The reference numerals in FIG. 2 correspond to the reference numerals in FIG. 1.

A clamping jaw 1 which is movably held on a guide 23 is shown in a three-dimensional view in FIG. 3.

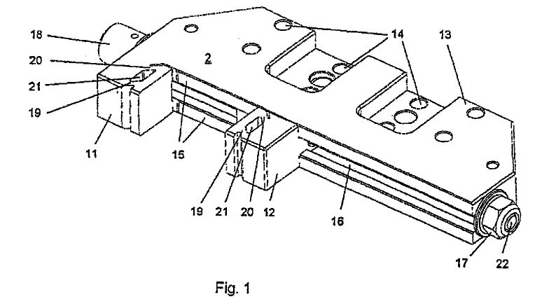

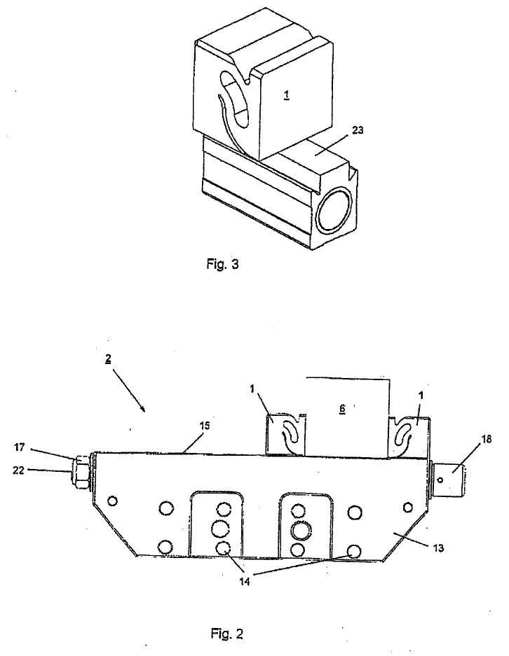

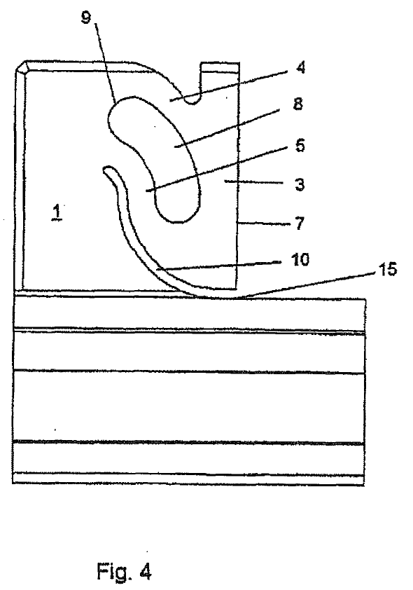

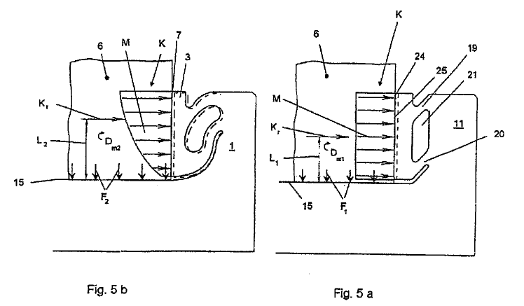

A possible configuration of a clamping jaw 1 can be seen in the side view in FIG. 4. The clamping jaw 1 has a clamping plate 3 with the surface 7 directed toward the workpiece 6. Furthermore, an outer and an inner bridge 4 and 5 are arranged in the clamping jaw 1. The inner and outer bridges 4 and 5 do not run in parallel. The inner bridge 5 is curved to a greater degree than the outer bridge 4 in order to achieve lower rigidity. On account of the spring properties thus achieved, it is possible for the surface 7 of the clamping plate 3 to be in full contact with the workpiece 6. The force relationships in the clamped state are described in more detail in FIGS. 5a and 5b. The embodiment shown here shows an outer bridge 4 of curved shape and an S-shaped inner bridge 5. The cavity 8 enclosed by the bridges 4 and 5 is provided with such curvatures 9 that overloading of the clamping jaws is prevented. Furthermore, a curved, for example S-shaped, slot 10 is provided as overload protection between the vise bed 15 and the inner bridge 5. The gap width formed by the slot 10 becomes zero if the torque produced during the clamping were to become too high.

FIGS. 5a and 5b show a comparison of the force relationships in the clamped state between a known clamping jaw and an exemplary clamping jaw according to the invention.

FIG. 5a shows the situation according to the prior art. The two bridges 19 and 20 enclose a parallelogram as cavity 21. The clamping force K is constant over the entire surface 24 of the clamping plane 25. The resultant force Kᵣ acts in the center M of the clamping plane 25, such that a torque Dₘ₁, formed from the resultant force Kᵣ and a distance L₁, is obtained.

The force flow in the case of the invention is different and is shown by way of example in FIG. 5b. As a result of the specially curved bridges 4 and 5, the clamping forces K decrease from top to bottom. The application point of the resultant force Kᵣ lies above the center M of the surface 7 of the clamping plate 3. The distance L₂ thus becomes greater than the distance L₁ in FIG. 5a. Consequently, compared with the prior art, the torque Dₘ₂ increases relative to the torque Dₘ₁. It is essential to achieve a maximum bending moment, which results from the forces Kᵣ and F₂ multiplied by the arm L₂. The workpiece is held in the critical bending direction by friction. The bending strength depends substantially on the length L₂.

The comparison of the force distribution of FIG. 5a with that of FIG. 5b shows that the force F₂ in FIG. 5b directed toward the vise bed 15 is greater than the force F₁ in FIG. 5a. The workpiece 6 in the example according to the invention is thus pulled downward to a greater extent and held more firmly, which is an essential aim of the invention.

The invention is not restricted to the curved shapes of the bridges and of the slot shown in the figures. It is essential to find such a geometry which results in a higher force in the direction of the vise bed compared with the prior art, with straight and parallel geometrical properties.

The advantages associated with the invention consist in particular in achieving a greater loading capacity and a greater clamping force at the same operating torque due to a suitable shape of the clamping jaws. For an operator, the manipulation of the vise having the clamping jaws according to the invention is less stressful on the joints and muscles.

1-10. (canceled)

11. A clamping jaw for a vise, comprises a clamping plate and at least two bridges, wherein a clamping force K of the clamping plate on a clamped workpiece is variable along a surface directed toward the workpiece.

12. The clamping jaw as claimed in claim 1, wherein the resultant clamping force Kᵣ lies above the center M of the surface of the clamping plate.

13. The clamping jaw as claimed in claim 13, wherein the clamping plate has an outer bridge and an inner bridge.

14. The clamping jaw as claimed in claim 13, wherein the outer bridge and the inner bridge are elastically flexible, wherein a spring constant of the inner bridge is less than the spring constant of a outer bridge.

15. The clamping jaw as claimed in claim 13, wherein the outer bridge and inner bridge are curved.

16. The clamping jaw as claimed in claim 15, wherein the outer bridge and inner bridge are curved differently.

17. The clamping jaw as claimed in claim 16, wherein the inner bridge has a greater curvature than the outer bridge.

18. The clamping jaw as claimed in claim 15, wherein the inner bridge is S-shaped.

19. The clamping jaw as claimed in claim 13, wherein the clamping jaw has a cavity between the inner bridge and the outer bridge, wherein the curvatures of the cavity avoid overloading.

20. The clamping jaw as claimed in claim 13, wherein the clamping jaw has a curved slot below the inner bridge for avoiding overloading.
